(19) United States
(12) Patent Application Publication
(10) Pub. No.: US 2025/0369800 A1
(43) Pub. Date: Dec. 4, 2025

(54) SYSTEM, METHOD AND APPARATUS FOR 3D HYPERSPECTRAL IMAGING

(71) Applicants: POSCO HOLDINGS INC., Pohang-si, (KR); POSTECH RESEARCH AND BUSINESS DEVELOPMENT FOUNDATION, Pohang-si (KR)

(72) Inventors: Su-Hyun SHIN, Pohang-si (KR); Seung-Hwan BAEK, Pohang-si (KR); Seok-Jun CHOI, Pohang-si (KR)

(73) Assignees: POSCO HOLDINGS INC., Pohang-si, (KR); POSTECH RESEARCH AND BUSINESS DEVELOPMENT FOUNDATION, Pohang-si (KR)

(21) Appl. No.: 19/177,005

(22) Filed: Apr. 11, 2025

(30) Foreign Application Priority Data
Jun. 4, 2024 (KR) 10-2024-0072842

(51) Int. Cl. G01J 3/28; G01J 3/18; H04N 13/254; H04N 13/257

(52) U.S. Cl. CPC G01J 3/2823; G01J 3/1838; H04N 13/254; H04N 13/257; G01J 2003/2826; G01J 2003/2836; G01J 2003/284

(57) ABSTRACT

Provided is a system, a method and an apparatus for 3D hyperspectral imaging, and the system for 3D hyperspectral imaging includes a projector configured to irradiate one or more patterns; a diffractive optical element disposed in front of the projector; a camera configured to obtain an image generated by a pattern, irradiated from the projector, passing through the diffractive optical element; and an imaging device configured to derive 3D information and hyperspectral information of pixels included in the image based on information of the pattern irradiated from the projector, wherein the imaging device derives the hyperspectral information by performing optimization for each pixel included in the image.

### CROSS-REFERENCE TO RELATED APPLICATION(S)

This application claims benefit of priority to Korean Patent Application No. 10-2024-0072842 filed on Jun. 4, 2024 in the Korean Intellectual Property Office, the disclosure of which is incorporated herein by reference in its entirety.

### BACKGROUND

### 1. Field

The present disclosure relates to a system, a method and an apparatus for 3d hyperspectral imaging.

### 2. Description of Related Art

3D hyperspectral imaging is a technology of simultaneously capturing depth maps and hyperspectral reflectance images from a scene, and enabling precise geometric-spectral analysis of points included in each scene.

Using 3D hyperspectral imaging, it may be possible to analyze both a geometric shape and material characteristics of an object. For example, the technology may be applied to various fields such as detecting the degree of ripeness of food, detecting the type or characteristics of minerals, and may also be applied to the authentication and classification of artworks or cultural heritage objects, or detecting or analyzing invisible objects.

General 3D hyperspectral imaging may be performed using a device in which an expensive hyperspectral sensor and a 3D camera are combined. In this case, high-resolution 3D hyperspectral data may be obtained, but there may be a limitation that practicality may be low due to high costs and size.

### SUMMARY

An embodiment of the present disclosure is to provide a system, a method and an apparatus for 3D hyperspectral imaging configured with a low cost, compact device which may have a high degree of accuracy.

An embodiment of the present disclosure is to provide a system, a method and an apparatus for 3D hyperspectral imaging which may restore 3D information and hyperspectral information with high accuracy using relationship between a pattern irradiated from a projector and an image passing through a diffractive optical element and obtained by a camera.

The present disclosure provides a system, a method and an apparatus for 3D hyperspectral imaging as below.

According to an embodiment of the present disclosure, a system for 3D hyperspectral imaging includes a projector configured to irradiate one or more patterns; a diffractive optical element disposed in front of the projector; a camera configured to obtain an image generated by a pattern, irradiated from the projector, passing through the diffractive optical element; and an imaging device configured to derive 3D information and hyperspectral information of pixels included in the image based on information of the pattern irradiated from the projector, wherein the imaging device derives the hyperspectral information by performing optimization for each pixel included in the image.

According to an embodiment of the present disclosure, a method for 3D hyperspectral imaging, performed by a computing device including a processor and a storage medium storing instructions executable by the processor includes receiving a first image generated by light of a first pattern passing through a diffractive optical element; deriving 3D information of pixels included in the first image based on information of the first pattern; receiving a second image generated by light of a second pattern passing through the diffractive optical element; and deriving hyperspectral information of pixels included in the second image based on information of the second pattern.

According to an embodiment of the present disclosure, an apparatus for 3D hyperspectral imaging includes a processor; and a storage medium configured to store instructions executable by the processor, wherein the processor is configured to, by executing the instructions, receive a first image generated by light of a first pattern passing through a diffractive optical element, derive 3D information of pixels included in the first image based on information of the first pattern, receive a second image generated by light of a second pattern passing through the diffractive optical element, and derive hyperspectral information of pixels included in the second image based on information of the second pattern.

### BRIEF DESCRIPTION OF DRAWINGS

The patent or application file of this patent contains at least one drawing executed in color. Copies of this patent with color drawing(s) will be provided by the Patent and Trademark Office upon request and payment of the necessary fee. The and other aspects, features, and advantages of the present disclosure will be more clearly understood from the following detailed description, taken in combination with the accompanying drawings, in which:

FIG. 1 is a diagram illustrating a system for 3D hyperspectral imaging according to an embodiment of the present disclosure;

FIG. 2A is a diagram illustrating a portion of components of a system for 3D hyperspectral imaging according to an embodiment of the present disclosure;

FIG. 2B is a diagram illustrating a portion of components of a system for 3D hyperspectral imaging according to an embodiment of the present disclosure;

FIGS. 3A, 3B and 3C are diagrams illustrating a system for 3D hyperspectral imaging according to an embodiment of the present disclosure;

FIG. 4A is a diagram illustrating a pattern and an image of a system for 3D hyperspectral imaging according to an embodiment of the present disclosure;

FIG. 4B is a diagram illustrating a white line pattern of a system for 3D hyperspectral imaging according to an embodiment of the present disclosure;

FIGS. 4C, 4D, 4E and 4F are diagrams illustrating a pattern and image of a system for 3D hyperspectral imaging according to an embodiment of the present disclosure;

FIG. 5 is a diagram illustrating a system for 3D hyperspectral imaging according to an embodiment of the present disclosure;

FIGS. 6A and 6B are diagrams illustrating a method for evaluating performance of a system for 3D hyperspectral imaging and a result of the evaluation according to an embodiment of the present disclosure;

FIGS. 7A, 7B, 7C, and 7F are diagrams illustrating another method for evaluating performance of a system for 3D hyperspectral imaging and a result of the evaluation according n embodiment of the present disclosure;

FIG. 8 is a diagram illustrating another method for evaluating performance of a system for 3D hyperspectral imaging and a result of the evaluation according to an embodiment of the present disclosure;

FIG. 9 is a flowchart illustrating a method for 3D hyperspectral imaging according to an embodiment of the present disclosure; and

FIG. 10 is a block diagram illustrating a computing device which may entirely or partially implement apparatus for 3D hyperspectral imaging according to an embodiment of the present disclosure.

### DETAILED DESCRIPTION

Hereinafter, embodiments of the present disclosure will be described as below with reference to the accompanying drawings.

The present disclosure is not limited to exemplary embodiments, and it is to be understood that various modifications may be made without departing from the spirit and scope of the present disclosure.

Also, descriptions of functions and constructions that are well known to one of ordinary skill in the art may be omitted for increased clarity and conciseness.

In the accompanying drawings, some elements may be exaggerated, omitted or briefly illustrated, and the sizes of the elements do not necessarily reflect the actual sizes of these elements.

Also, redundant descriptions and detailed descriptions of known functions and elements which may unnecessarily render the gist of the present disclosure obscure will be omitted. The terms described below are defined in consideration of functions thereof in the present disclosure, and may vary depending on the intention or custom of a user or operator. Accordingly, the definitions thereof should be based on the descriptions throughout this specification. Terms used in the present specification are for explaining the embodiments rather than limiting the present invention. Unless explicitly described to the contrary, a singular form includes a plural form in the present specification.

The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

Unless otherwise indicated in the present disclosure, % unit indicates weight %.

The terms such as “upper” “upper portion” “upper surface,” “lower,” “lower portion,” “lower surface,” “side surface,” and the like, are based on the drawing and may actually vary depending on the direction in which the elements or components are arranged.

In the embodiments, the term “connected” may not only refer to “directly connected” but also include “indirectly connected” with another component interposed therebetween.

It should be noted that embodiments or examples described in this specification is not limited to a single embodiment or example, and may be combined with other embodiments or examples. Accordingly, the patent claims is only an example of an embodiment, and the technical idea of the present disclosure should not be interpreted merely as a combination with the claim, and the combination with various claims is also included in the scope of the technical idea of the present disclosure.

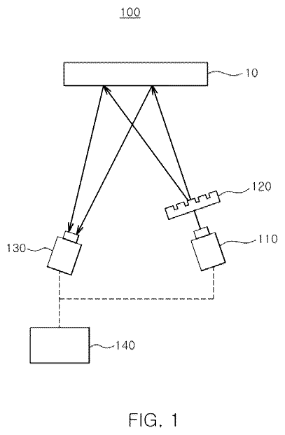

FIG. 1 is a diagram illustrating a system for 3D hyperspectral imaging according to an embodiment. Referring to FIG. 1, the system 100 for 3D hyperspectral imaging may include a projector 110, a diffractive optical element 120, a camera 130, and an imaging device 140.

The system 100 for 3D hyperspectral imaging according to an embodiment may obtain 3D information and hyperspectral information from an image captured by the camera 130 after light of a pattern irradiated from the projector 110 passes through the diffractive optical element 120 and is reflected from an object 10.

The 3D information and the hyperspectral information obtained by the system 100 for 3D hyperspectral imaging may be applied to predict properties or characteristics of an object.

The system 100 for 3D hyperspectral imaging according to an embodiment may obtain 3D information and hyperspectral information with high accuracy using a low-cost, compact device configuration.

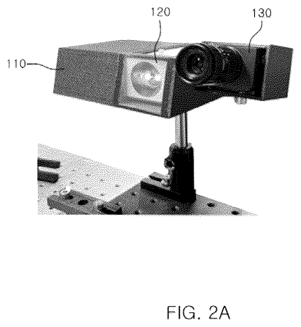

FIG. 2A may illustrates an example of a state in which a projector 110, a diffractive optical element 120, and a camera 130 of the system 100 for 3D hyperspectral imaging according to an embodiment are installed.

Referring to FIG. 2B, light of a pattern 111 irradiated from the projector 110 may reach the object 10 while being spatially diffused through the diffractive optical element 120. The camera 130 may receive light reflected from the object 10 and may obtain an image 131.

The image 131 obtained by the camera 130 may include a 1st-order signal 131a and a 0th-order signal 131b as illustrated in FIG. 2B.

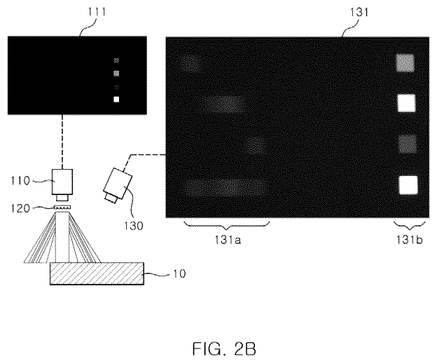

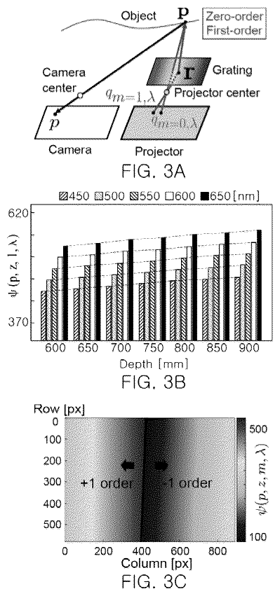

FIG. 3A may schematically illustrate the example an image is formed by a 0th-order signal and a 1st-order signal in the system 100 for 3D hyperspectral imaging.

As illustrated in FIG. 3A, a pixel (p) included in an image obtained by the camera 130 may be generated by reflecting a 0th-order signal, obtained by a pixel (qm=0, λ) included in the pattern, irradiated from projector 110, passing through a diffractive optical element 120, from the object 10 and reflecting a 1st-order signal, obtained by a pixel (qm=1, λ) other than the pixels included in the pattern and passing through the diffractive optical element 120, from the object 10.

FIG. 3B is a graph illustrating depth dependence of responsiveness, and FIG. 3C is a graph illustrating spatial responsiveness by pixel position. The 1st-order signal passing through the diffractive optical element 120 may include a +1th-order signal and a −1th-order signal.

The projector 110 may include a light output unit for irradiating a predetermined pattern. The projector 110 may irradiate one or more patterns. The pattern irradiated by the projector 110 may include one or more pixels.

In an embodiment, the projector 110 may be implemented as a standard trichromatic projector.

The one or more patterns may include different first patterns and second patterns. For example, the first pattern may be configured as a gray code pattern, and the second pattern may be configured as a white line pattern. The white line pattern may include a white line moving in one direction with a predetermined distance.

The diffractive optical element 120 may propagate light incident in one direction in different directions according to a wavelength. The diffractive optical element 120 may be disposed in front of a light output unit from which light is output from the projector 110.

The diffractive optical element 120 may include, for example, a diffraction grating film. The diffraction grating film may include a micro-scale repeating structure. Depending on grating density of the diffraction grating film, diffraction characteristics may appear differently.

Light of the pattern irradiated from the projector 110 may be spatially diffused according to a wavelength while passing through the diffractive optical element 120.

In an embodiment, the diffractive optical element 120 may be a holographic diffraction grating film.

Among the diffractive optical elements, a blazed diffraction grating film exhibits high efficiency for a specific order or wavelength, and low efficiency for a 0th-order signal. Also, when using a blazed diffraction grating film, a ghost phenomenon may occur, and errors may occur substantially.

In contrast, when using a holographic diffraction grating film, less error may occur than using a blazed diffraction grating film and higher efficiency may be obtained in a 0th-order signal than a 1st-order signal, which may be advantageous.

Accordingly, when using a holographic diffraction grating film as the diffractive optical element 120, unnecessary errors occurring when restoring hyperspectral information may be reduced.

The camera 130 may obtain an image generated by a pattern, irradiated from the projector 110, passing through the diffractive optical element 120.

In an embodiment, the camera 130 may be an RGB camera.

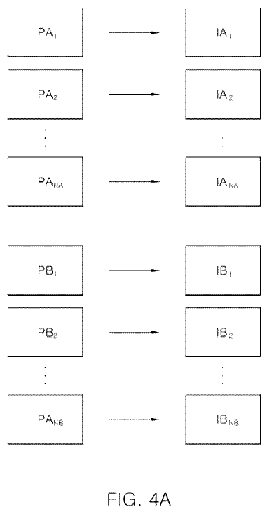

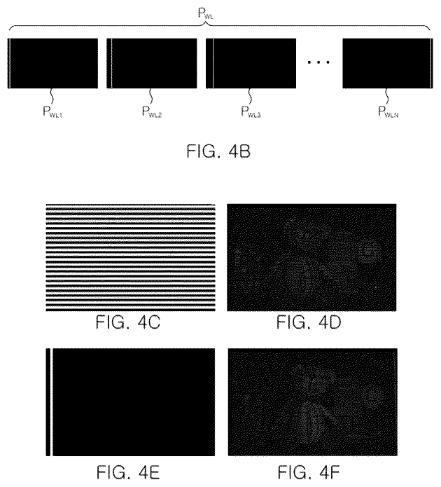

For example, as illustrated in FIG. 4A, when the first pattern PA₁, PA₂, . . . , PA_{NA} is irradiated from the projector 110, the camera 130 may obtain the first image IA₁, IA₂, . . . , IA_{NA} generated by light of the first pattern (Here, NA is a natural number equal to or greater than 3).

When the first pattern PA₁, PA₂, . . . , PA_{NA} includes NA number of the pattern frames, the first image IA₁, IA₂, . . . , IA_{NA} may include NA number of image frames of corresponding to each pattern frame of the first pattern.

Also, when the second patterns PB₁, PB₂, . . . , PB_{NB} is irradiated from the projector 110, the camera 130 may obtain the second images IB₁, IB₂, . . . , IB_{NB} generated by light of the second pattern (Here, NB is a natural number equal to or greater than 3).

When the second patterns PB₁, PB₂, . . . , PB_{NB} includes NB number of pattern frames, the second images IB₁, IB₂, . . . , IB_{NB} may include NB number of image frames corresponding to each pattern frame of the second pattern.

In an embodiment, the first pattern may be a gray code pattern, and the second pattern may be a white line pattern.

The gray code pattern may be based on a binary code, and may be designed such that a change in value between adjacent pixels includes only one bit. Using the gray code pattern, an error in pattern recognition may be reduced.

The white line pattern may include a white line moving in one direction with a predetermined distance.

FIG. 4B may illustrate a white line pattern as an example. As illustrated in FIG. 4B, the white line pattern P_{WL} may include N number of pattern frames, such as P_{WL1}, P_{WL2}, P_{WL3}, . . . , P_{WLN}, in which white lines moving in one direction with a predetermined distance are included.

In an embodiment, a predetermined distance of a white line in the white line pattern is 2 pixels, and the number of pattern frames, N, may be 317.

FIGS. 4C, 4D, 4E and 4F may illustrate patterns and images of the system 100 for 3D hyperspectral imaging. FIG. 4C may illustrate a pattern frame of one of gray code patterns, and FIG. 4D may illustrate an image generated by light of the pattern illustrated in FIG. 4C. Also, FIG. 4E may illustrate a pattern frame of one of white line patterns, and FIG. 4F may illustrate an image generated by light of the pattern illustrated in FIG. 4E.

Referring back to FIG. 1, an imaging device 140 of the system 100 for 3D hyperspectral imaging may derive 3D information and hyperspectral information of pixels included in an image obtained by the camera 130.

The imaging device 140 may be connected to the projector 110 and the camera 130, and may transmit and receive data therebetween. For example, the imaging device 140 may receive information of a pattern irradiated by the projector 110 from the projector 110. Also, the imaging device 140 may receive an image obtained by the camera 130 from the camera 130.

The imaging device 140 may derive 3D information and hyperspectral information of pixels based on information of a pattern irradiated by the projector 110.

In embodiments, provide high-precision 3D hyperspectral imaging based on relationship between the pattern irradiated by the projector 110 and the image obtained by the camera 130. In embodiments, high-precision 3D hyperspectral imaging may be provided using dispersed structured light.

For example, when the first pattern is irradiated from the projector 110 and the first image is obtained by the camera 130, the imaging device 140 may derive 3D information of the pixels based on the information of the first pattern and the first image. The first pattern may be configured as a gray code pattern.

The imaging device 140 may derive 3D information using 0th-order signal information of the pixels included in the first image.

For example, the 3D information of the pixels may be derived using triangulation. In equation 1, p is a pixel included in the image obtained by the camera 130, q is a pixel corresponding to p among pixels included in the pattern irradiated by the projector, D(x) is a decoding function of the gray code pattern, and En(x) is an encoding function of the gray code pattern.

$$q = arg min ( D ( e ( p ) , En ( q ) ) \qquad [ Equation 1 ]$$

In equation 1, pixel q corresponding to pixel p included in the pattern irradiated by the projector may be derived by equation 1.

For another example, when a second pattern is irradiated from the projector 110 and a second image is obtained by the camera 130, the imaging device 140 may derive hyperspectral information of the pixels based on the information of the second pattern and the second image. The second pattern may be configured as a white line pattern. The white line pattern may include a white line moving in one direction with a predetermined distance.

The imaging device 140 may derive hyperspectral information using a 0th-order signal information and a 1st-order signal information of the pixels included in the second image.

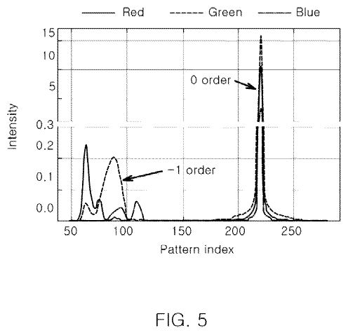

FIG. 5 is a graph illustrating intensity of each RGB channel of pixels included in an image obtained by the camera 130 to which the white line pattern from the projector 110 is irradiated.

In the example illustrated in FIG. 5, a signal having the highest intensity in each RGB channel may be estimated to be the 0th-order signal, and the signal having the next highest intensity may be estimated to be the 1st-order signal.

The imaging device 140 may derive hyperspectral information by performing optimization for each pixel included in the second image. The imaging device 140 may perform optimization for each pixel using the gradient descent method.

The imaging device 140 may derive hyperspectral information minimizing restoration loss based on an intensity value for each RGB channel of pixels included in the second image.

The imaging device 140 may derive hyperspectral information based on intensity values of the pixels of the second pattern corresponding to the pixels included in the second image, diffraction efficiency by the diffractive optical element 120, reflection efficiency reflected from an object toward the camera 130, and recognition efficiency of the camera 130.

The imaging device 140 may derive restoration loss based on the first weight according to a diffraction order. Also, the imaging device 140 may derive normalization information for hyperspectral information based on the second weight according to the wavelength.

For example, hyperspectral information of pixels may be derived using equation 2. In equation 2, m is a diffraction order, λ is a wavelength, Aₘ is a system matrix, H is hyperspectral information, Iₘ is an intensity of an image obtained by a camera, Kₘ is a first weight according to the diffraction order, and K_{λ} may be a second weight according to the wavelength.

$${arg min}_{H} {\underbrace{{\sum }_{m = - 1}^{1} {K}_{m} {‖ {A}_{m} H - {I}_{m} ‖}_{2}^{2}}}_{Data term} + {\underbrace{{K}_{λ} {‖ {∇}_{λ} H ‖}_{2}^{2}}}_{Regularization term} \qquad [ Equation 2 ]$$

In equation 2, the system matrix Aₘ may be derived using equation 3. In equation 3, L is intensity of the pattern, q is the pixels included in the pattern, m is the diffraction order, λ is the wavelength, c is one of the RGB channels, Ω^{cam} is recognition efficiency of camera 130, and η may be diffraction efficiency by the diffractive optical element 120.

$${A}_{m} = \{ \begin{matrix}{\sum }_{λ} {Ω}_{c , λ}^{cam} {η}_{m , λ} L ( {q}_{m , λ} , λ ) \\ {Ω}_{c , λ}^{cam} {η}_{m , λ} L ( {q}_{m , λ} , λ )\end{matrix} \qquad [ Equation 3 ]$$

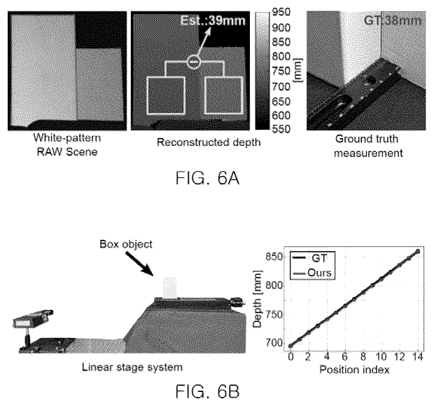

FIGS. 6A to 8 may illustrate a method for evaluating performance of the system 100 for 3D hyperspectral imaging in embodiments and a result of the evaluation.

FIG. 6A illustrates a method for evaluating a relative depth, in which a depth difference between two planes positioned at different depths was derived. As a result of the relative depth evaluation, when the actual depth difference GT is 38 mm, the depth difference derived by the system 100 for 3D hyperspectral imaging was 39 mm, confirming that a depth error of 1 mm was obtained.

FIG. 6B illustrates a method for evaluating an absolute depth, in which a planar object mounted on a linear moving stage is photographed and an absolute depth error was measured. As a result of the absolute depth evaluation, it was confirmed that the system 100 for 3D hyperspectral imaging exhibited an average depth error of 1.35 mm with a step size of 10 mm throughout an operating range of the moving stage.

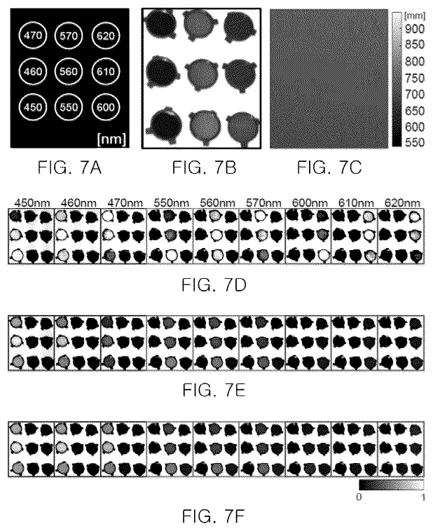

FIGS. 7A, 7B, 7C, 7D, 7E and 7F are a method for evaluating degree of restoration of a high-frequency hyperspectral object, and the degree of restoration of hyperspectral information was evaluated using nine bandpass filters with wavelengths of blue, green, and red series having different wavelengths.

FIG. 7A indicates wavelengths of nine bandpass filters, FIG. 7B indicates three primary color images of restored hyperspectral imaging according to the wavelengths illustrated in FIG. 7A, and FIG. 7C shows a restored depth map according to the wavelengths illustrated in FIG. 7A.

FIG. 7D indicates the restoration result according to an embodiment, FIG. 7E indicates the restoration result excluding the 1st-order signal information from the system 100 for 3D hyperspectral imaging in an embodiment, and FIG. 7F indicates the restoration result using a comparison technique. As indicated in FIG. 7D, in the embodiment, it was confirmed that, using both 0th-order signal and 1st-order signal information, even a wavelength difference of 10 mm may be accurately distinguished and restored.

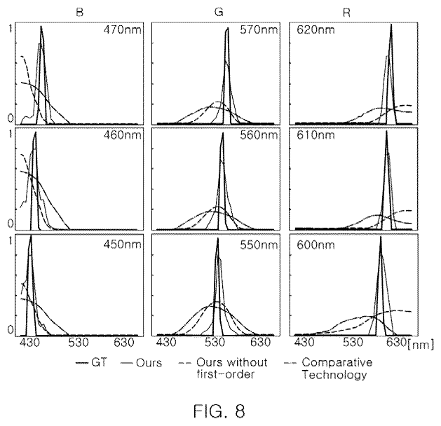

FIG. 8 may illustrate the results of evaluating hyperspectral reflectivity using nine bandpass filters. As illustrated in FIG. 8, in the embodiment, it was confirmed that high-accuracy restoration performance was obtained such that intensity exhibited to be similar to the correct intensity graph GT.

In the embodiment, restoration performance of hyperspectral information may improve by using both 0th-order signal information and 1st-order signal information.

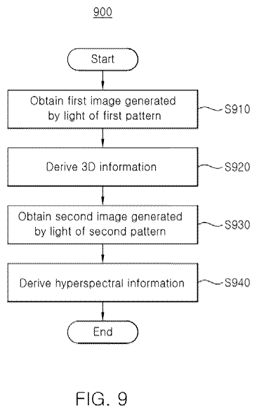

FIG. 9 is a flowchart of a method for 3D hyperspectral imaging according to an embodiment. Referring to FIG. 9, a method for 3D hyperspectral imaging (S900) may include obtaining a first image generated by light of a first pattern (S910), deriving 3D information (S920), obtaining a second image generated by light of a second pattern (S930), and deriving hyperspectral information (S940).

In the obtaining the first image generated by light of the first pattern (S910), the first pattern may include a gray code pattern.

In the obtaining the first image generated by light of the first pattern (S910), the first image may be generated by light of the first pattern passing through the diffractive optical element and reflected from an object.

In the deriving 3D information (S920), 3D information may be derived using the 0th-order signal information of the pixels included in the first image.

The deriving 3D information (S920) may include deriving pixel information of the first pattern corresponding to the pixels included in the first image and deriving 3D information using the pixel information of the first pattern and the 0th-order signal information of the pixels included in the first image.

In the obtaining a second image generated by light of the second pattern (S930), the second pattern may include a white line pattern.

In the obtaining a second image generated by light of the second pattern (S930), the second image may be generated by light of the second pattern reflected from an object through a diffractive optical element.

In the deriving hyperspectral information (S940), hyperspectral information may be derived using the 0th-order signal information and the 1st-order signal information of pixels included in the second image.

The deriving hyperspectral information (S940) may include deriving pixel information of the second pattern corresponding to pixels included in the second image and deriving hyperspectral information using pixel information of the second pattern and the 0th-order signal information and the 1st-order signal information of pixels included in the second image.

The pixels of the second pattern corresponding to the pixels included in the second image may include pixels corresponding to the 0th-order signal and pixels corresponding to the 1st-order signal.

In the deriving hyperspectral information (S940), optimization may be performed for each pixel included in the second image using a gradient descent method.

The deriving hyperspectral information (S940) may further include deriving hyperspectral information minimizing restoration loss based on an intensity value of each RGB channel of pixels included in the second image.

The deriving hyperspectral information (S940) may further include deriving restoration loss based on the first weight according to the diffraction order and deriving normalization information hyperspectral information based on the second weight according to the wavelength.

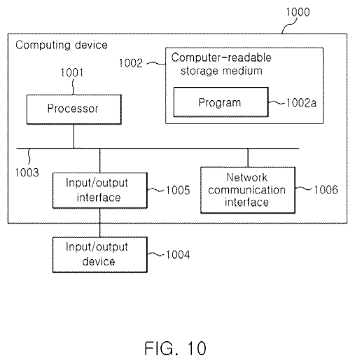

FIG. 10 is a block diagram illustrating a computing device 1000 which may entirely or partially implement an apparatus for 3D hyperspectral imaging according to an embodiment, which may be the imaging device 140 included in the system 100 for 3D hyperspectral imaging illustrated in FIG. 1.

As illustrated in FIG. 10, the computing device 1000 may include at least one processor 1001, a computer-readable storage medium 1002, and a communication bus 1003.

The processor 1001 may allow the computing device 1000 to operate according to the aforementioned embodiment. For example, the processor 1001 may execute one or more programs stored in the computer-readable storage medium 1002. The one or more programs may include one or more computer-executable instructions, and when the instructions are executed by the processor 1001, the computing device 1000 may perform operations according to the embodiment.

The computer-readable storage medium 1002 may be configured to store computer-executable instructions or program code, program data, and/or other suitable forms of information. A program 1002a stored in a computer-readable storage medium 1002 may include a set of instructions executable by the processor 1001. In an embodiment, the computer-readable storage medium 1002 may be memory (volatile memory, such as random access memory, nonvolatile memory, or a suitable combination thereof), one or more magnetic disk storage devices, optical disk storage devices, flash memory devices, or any other form of storage media which may be accessed by the computing device 1000 and may store desired information, or a suitable combination thereof.

A communication bus 1003 may include the processor 1001 and the computer-readable storage medium 1002 and may interconnect various other components of the computing device 1000.

The computing device 1000 may also include one or more input/output interfaces 1005 and one or more network communication interfaces 1006 providing interfaces for one or more input/output devices 1004. The input/output interface 1005 and the network communication interface 1006 may be connected to the communication bus 1003.

The network communication interface 1006 may be implemented as an interface for communication in a vehicle or for communication between a vehicle and other devices outside the vehicle, and may include, for example, controller area network (CAN), media oriented systems transport (MOST) network, local interconnect network (LIN) and/or X-by-Wire (Flexray), Wi-Fi, Bluetooth, NFC, RFID, or the like. The network may be implemented as a cellular network, for example, global system for mobile communications (GSM), enhanced data rates for GSM Evolution (EDGE), general packet radio service (GPRS), code division multiple access (CDMA), time division-CDMA (TD-CDMA), universal mobile telecommunications system (UMTS), long term evolution (LTE), or any other cellular network.

The input/output device 1004 may be connected to other components of the computing device 1000 through the input/output interface 1005. The exemplary input/output device 1004 may include input devices such as a pointing device (such as a mouse or trackpad), a keyboard, a touch input device (such as a touchpad or a touchscreen), a voice or audio input device, various types of sensor devices, and/or imaging devices, and/or output devices such as a display device, a printer, speakers, and/or a network card. The exemplary input/output device 1004 may be included in the computing device 1000 as a component included in the computing device 1000, or may be connected to the computing device 1000 as a separate device distinct from the computing device 1000.

The embodiment may include a program for performing the methods described in the present specification on a computer, and a computer-readable recording medium including the program. The computer-readable recording medium may include program commands, local data files, local data structures, or the like, alone or in combination. The medium may be specially designed and configured for the embodiment, or may be commonly used in the computer software field. Examples of the computer-readable recording medium may include magnetic media such as a hard disk, a floppy disk, and a magnetic tape, optical recording media such as CD-ROM and DVD, and hardware devices specially configured to store and execute program commands such as ROM, RAM, and flash memory. Examples of the program may include machine language codes generated by a compiler, and also high-level language codes which may be executed by a computer using an interpreter, or the like.

According to the aforementioned embodiments, a method and an apparatus for 3D hyperspectral imaging configured with low cost and compact device which may have high accuracy may be provided.

Also, a system, a method and an apparatus for 3D hyperspectral imaging which may restore 3D information and hyperspectral information with high accuracy using relationship between a pattern irradiated from a projector and an image passing through a diffractive optical element and obtained by a camera may be provided.

Also, 3D hyperspectral imaging may be provided using dispersed structured light (DSL).

While the embodiments have been illustrated and described above, it will be configured as apparent to those skilled in the art that modifications and variations could be made without departing from the scope of the present disclosure as defined by the appended claims.

What is claimed is:

1. A system for 3D hyperspectral imaging, the system comprising:
a projector configured to irradiate one or more patterns;
a diffractive optical element disposed in front of the projector;
a camera configured to obtain an image generated by a pattern, irradiated from the projector, passing through the diffractive optical element; and
an imaging device configured to derive 3D information and hyperspectral information of pixels included in the image based on information of the pattern irradiated from the projector,
wherein the imaging device derives the hyperspectral information by performing optimization for each pixel included in the image.

2. The system of claim 1, wherein
wherein the one or more patterns include first patterns and second patterns different from each other,
wherein the camera obtains a first image generated by light of the first pattern and a second image generated by light of the second pattern, and
wherein the imaging device derives the 3D information based on information of the first pattern and the first image, and derives the hyperspectral information based on information of the second pattern and the second image.

3. The system of claim 2,
wherein the first pattern is configured as a gray code pattern, and
wherein the imaging device derives the 3D information using 0th-order signal information of pixels included in the first image.

4. The system of claim 2,
wherein the second pattern is configured as a white line pattern including a white line moving in one direction with a predetermined distance, and
wherein the imaging device derives the hyperspectral information using 0th-order signal information and 1st-order signal information of pixels included in the second image.

5. The system of claim 4, wherein the imaging device derives the hyperspectral information minimizing restoration loss based on an intensity value of each RGB channel of pixels included in the second image.

6. The system of claim 5, wherein the imaging device derives the hyperspectral information further based on an intensity value of pixels of the second pattern corresponding to pixels included in the second image, diffraction efficiency by the diffractive optical element, reflection efficiency reflected from an object toward the camera, and recognition efficiency of the camera.

7. The system of claim 6, wherein the imaging device derives the restoration loss based on a first weight according to a diffraction order, and derives normalization information for the hyperspectral information based on a second weight according to a wavelength.

8. The system of claim 1, wherein the imaging device performs the optimization using a gradient descent method.

9. The system of claim 1, wherein the diffractive optical element is configured as a holographic diffraction grating film.

10. A method for 3D hyperspectral imaging, performed by a computing device including a processor and a storage medium storing instructions executable by the processor, the method comprising:
receiving a first image generated by light of a first pattern passing through a diffractive optical element;
deriving 3D information of pixels included in the first image based on information of the first pattern;
receiving a second image generated by light of a second pattern passing through the diffractive optical element; and
deriving hyperspectral information of pixels included in the second image based on information of the second pattern.

11. The method of claim 10, wherein the deriving hyperspectral information of pixels included in the second image includes deriving the hyperspectral information by performing optimization for each pixel included in the second image using a gradient descent method.

12. The method of claim 10,
wherein the first pattern includes a gray code pattern, and
wherein the second pattern includes a white line pattern.

13. The method of claim 12, wherein the deriving 3D information of pixels included in the first image based on information of the first pattern includes:
deriving pixel information of the first pattern corresponding to pixels included in the first image; and
deriving 3D information using pixel information of the first pattern and 0th-order signal information of pixels included in the first image.

14. The method of claim 12, wherein the deriving hyperspectral information of pixels included in the second image includes:
deriving pixel information of the second pattern corresponding to pixels included in the second image; and
deriving the hyperspectral information using pixel information of the second pattern and 0th-order signal information and 1st-order signal information of pixels included in the second image.

15. The method of claim 14, wherein the deriving hyperspectral information of pixels included in the second image includes deriving the hyperspectral information minimizing restoration loss based on an intensity value of each RGB channel of pixels included in the second image.

16. The method of claim 15, wherein the deriving hyperspectral information of pixels included in the second image includes
deriving restoration loss based on a first weight according to a diffraction order; and
deriving normalization information for the hyperspectral information based on a second weight according to a wavelength.

17. An apparatus for 3D hyperspectral imaging, the apparatus comprising:
a processor; and
a storage medium configured to store instructions executable by the processor,
wherein the processor is configured to, by executing the instructions:
receive a first image generated by light of a first pattern passing through a diffractive optical element,
derive 3D information of pixels included in the first image based on information of the first pattern,
receive a second image generated by light of a second pattern passing through the diffractive optical element, and
derive hyperspectral information of pixels included in the second image based on information of the second pattern.

18. The apparatus of claim 17, wherein the processor is further configured to derive the hyperspectral information by performing optimization for each pixel included in the second image using a gradient descent method.

19. The apparatus of claim 18, wherein the processor is further configured to:
derive the 3D information using 0th-order signal information of pixels included in the first image, and
derive the hyperspectral information using 0th-order signal information and 1st-order signal information of pixels included in the second image.

20. The apparatus of claim 19, wherein the processor is further configured to derive the hyperspectral information minimizing restoration loss based on an intensity values of each RGB channel of pixels included in the second image.
